(19) United States
(12) Patent Application Publication
(10) Pub. No.: US 2025/0229828 A1
(43) Pub. Date: Jul. 17, 2025

(54) TRANSPORTATION DEVICE WITH MULTIPLE FUNCTIONALITIES

(71) Applicant: LEVTEK SWEDEN AB, Malmö (SE)

(72) Inventors: Hannes BERGKVIST, Rydebäck (SE); Jake SNOWDON, Malmö (SE)

(21) Appl. No.: 18/848,609

(22) PCT Filed: Mar. 24, 2023
(86) PCT No.: PCT/SE2023/050266

§ 371 Date: Sep. 19, 2024

(30) Foreign Application Priority Data
Mar. 24, 2022 (EP) 2250365-0

(51) Int. Cl. B62D 5/04; B60N 2/04; B62D 1/183; B62D 33/02; B62D 51/04

(52) U.S. Cl. CPC B62D 5/04; B60N 2/04; B62D 1/183; B62D 33/02; B62D 51/04

(57) ABSTRACT

The present invention describes a transportation device 1 comprising multiple motorized wheels, for propulsion of the transportation device 1, wherein the transportation device 1 comprises at least one user ride-on unit 50, wherein the transportation device 1 has at least 4 wheels 4L, 4R, 5L, 5R, and wherein the transportation device 1 comprises a frame 70 arranged to provide a standing and/or walking space for the user.

### FIELD OF THE INVENTION

The present invention relates to a transportation device with multiple functionalities.

### TECHNICAL BACKGROUND

Most people on occasions have a need to walk from point A to B while carrying more load than they can manually. There are existing products that address this need, such as shopping trolleys, shopping carts and trundlers etc. In many scenarios there is a need to switch to a faster transport than walking. The most common product addressing this need is a bicycle with a carry tray and or basket. However, the load carrying capabilities are often also needed indoors, in a grocery store for example, where certain existing solutions, such as bicycles are not permitted or suitable. For load carrying, a person's manual strength is not always sufficient, for example in scenarios with heavy loads or steep inclines, in which case motorized assistance can be used.

To summarize, there is a need for a transportation device with multiple functionalities considering all of the needs mentioned above.

### SUMMARY OF A FIRST OBJECT OF THE INVENTION

According to a first aspect, the present invention provides a transportation device comprising multiple motorized wheels, for propulsion of the transportation device, wherein the transportation device comprises at least one user ride-on unit, wherein the transportation device has at least 4 wheels, and wherein the transportation device comprises a frame arranged to provide a standing and/or walking space for the user.

In relation to the above it may be mentioned that e.g. either two wheels or all four wheels may be motorized.

The transportation device according to the present invention has the capability to carry a load, has an ergonomic design, is possible to push manually and walk with, has the capability to provide motorized walking assistance, as well as ride-on capabilities, all while being suitable for both indoor and outdoor use.

Moreover, the transportation device provides a novel solution that enables multiple modes of transportation:
Walking manually with support for load carrying capabilities;
Walking with motorized assistance, for load/distance/inclination/safety/etc.; and
Ride-on (sit, stand etc.), for traveling at higher speeds and/or longer distances.

The multi-functional device according to the present invention has several advantages. First of all it enables seamless switching between transportation modes without any mechanical transformation/adjustments needed. This implies that in the fixed state the transportation device can be used for all three methods of transportation. Moreover, according to some embodiments the device according to the present invention is possible to adjust/modify/customize in order optimize the function for a specific transportation mode or a variation of a transport mode, for example sitting ride-on.

Moreover, the transportation device according to the present invention enables the transportation device to be self-balancing/standing in both active and resting/idle states, without the need of side-stands or other temporary stabilizers. Furthermore, the transportation device according to the present invention enables walking with a natural gait, implying that a) There is no part of the device between the feet; b) Both hands can hold the device while still at their respective sides of the body and c) There is forward foot clearance. This implies that feet and legs have free space to move past and in between the rear wheels.

Further benefits of the present invention will be presented below, both in relation to certain specific embodiments and also with reference to the appended drawings.

### BRIEF DESCRIPTION OF THE DRAWINGS

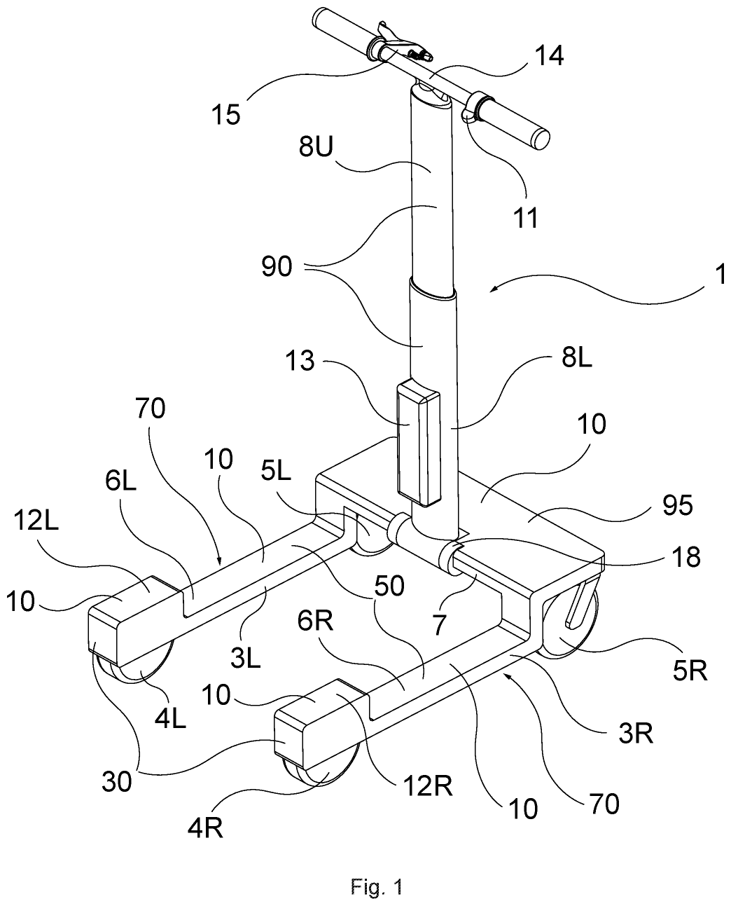

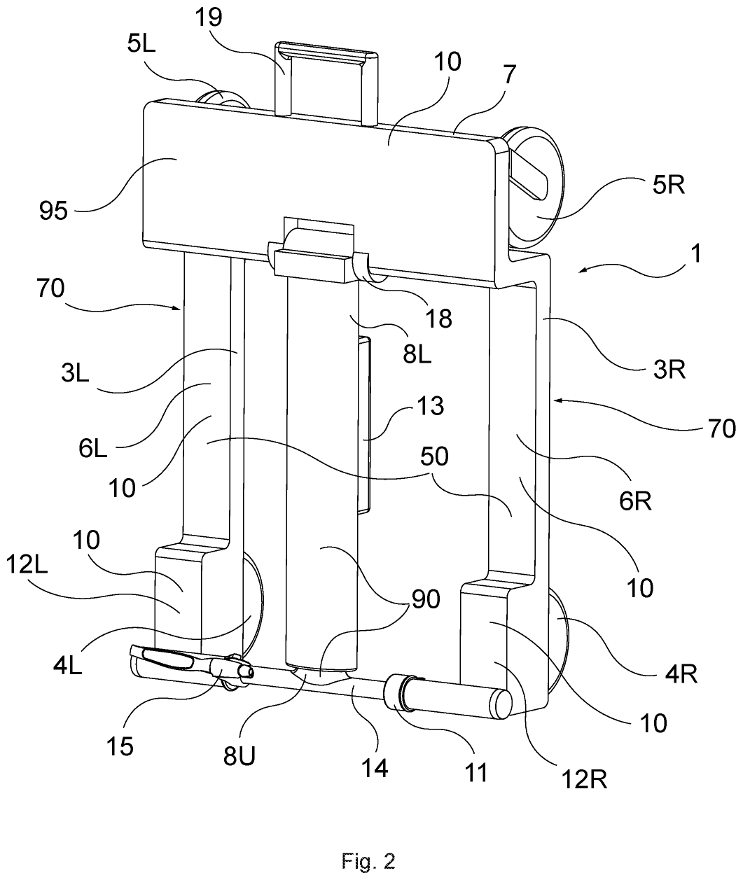

In FIGS. 1 and 2 there are shown one embodiment of the present invention.

### FURTHER OBJECTS AND SPECIFIC EMBODIMENTS OF THE INVENTION

Below there is provided and further described some specific embodiments of the present invention.

According to one embodiment, said at least one ride-on unit is two separate user standing portions. This may be provided as a left standing portion and a right standing portion. One such alternative is shown in FIGS. 1 and 2. Furthermore, and also shown in the figures, according to yet another embodiment of the first object, the transportation device also comprises a loading surface, preferably several loading surfaces, and wherein at least one loading surface is positioned on top of a front frame portion.

### A SECOND ASPECT OF THE PRESENT INVENTION

In line with what has been disclosed above, according to a second aspect, the present invention provides a transportation device comprising multiple motorized wheels, for propulsion of the transportation device, wherein the transportation device comprises at least one user ride-on unit, wherein the transportation device has at least 4 wheels, and wherein said at least one ride-on unit is two separate user standing portions.

Furthermore, also in this case, according to one embodiment, the transportation device comprises a frame arranged to provide a standing and/or walking space for the user. Moreover, according to yet another embodiment, the transportation device also comprises a loading surface, preferably several loading surfaces, and where at least one loading surface is positioned on top of the front frame portion.

### A THIRD ASPECT OF THE PRESENT INVENTION

According to a third aspect, the present invention provides a transportation device comprising multiple motorized wheels, for propulsion of the transportation device, wherein the transportation device comprises at least one user ride-on unit, wherein the transportation device has at least 4 wheels, and wherein the transportation device also comprises a loading surface, preferably several loading surfaces, and wherein at least one loading surface is positioned on top of a front frame portion. Also in this case, according to one embodiment, the transportation device comprises a frame arranged to provide a standing and/or walking space for the user. Moreover, according to yet another embodiment, said at least one ride-on unit is two separate user standing portions.

### SPECIFIC EMBODIMENTS OF THE PRESENT INVENTION

Below specific embodiments of the present invention are presented and described further. These embodiments are all relevant and possible for the different aspects of the present invention mentioned above.

The loading surface may be arranged at different positions. According to one example the loading surface is provided in the front, which is one suitable example, but other alternatives are of course possible. The loading surface may also be divided into two or more such loading surfaces. According to one alternative, the loading surface has a minimum loading surface of 100 cm², e.g. larger than 200 cm² (see below). According to one embodiment, a front loading surface, explained below, has a minimum loading surface area of 100 cm². According to yet another embodiment, the transportation device has multiple loading surfaces where the minimum total loading surface area is 200 cm². Furthermore, the transportation device may have other loading surfaces, such as extra plates on the side, or be arranged for such extra loading surfaces to be attached to the transportation device. In such cases, the minimum total loading surface area may be increased, such as being minimum 300 cm². Moreover, it should be noted that the transportation device according to the present invention has multiple functionalities and the standing and/or walking space may also be transformed into loading surfaces when suitable means are provided in that space, e.g. attached between two of the standing portions. If this space is used as a loading surface, the minimum total surface area is 800 cm².

According to one embodiment, the transportation device comprises two loading surfaces positioned at the part of the frame positioned above each front wheel, said two loading surfaces located on either side of a steering column. In this context it should be noted that the loading surfaces are located to form at least some loading area vertically above the wheels, however may distribute in different directions from the frame. Moreover, according to yet another embodiment, the transportation device comprises at least one loading surface which is a front loading surface positioned at the part of the frame positioned above each front wheel, said one front loading surface extends on both sides of a steering column, preferably, and as mentioned, said one front loading surface has a minimum surface area of 100 cm². In relation to above it should be mentioned that the front loading surface may extend in any direction or all directions from the steering column. Even a front loading surface extending backwards from the steering column towards the standing and/or walking space for the user is possible according to the present invention.

In regard to the loading surface(s) according to the present invention, it should be noted that also other loading capabilities are possible, either instead of or as an add-on. Examples are loading means in the form of boxes, trays, racks etc.

Furthermore, as should be understood from above, the transportation device according to the present invention may comprise multiple loading surfaces. Moreover, any or several of the loading surfaces may have fastening details for fixation of load carrying accessories. Moreover, one or more loading surfaces may also function as a mounting surface for accessories for extending the loading capabilities. Furthermore, the transportation device according to the present invention may also have accessories for other purposes and not only for load carrying.

As said, the transportation device according to the present invention comprises at least 4 wheels. Preferably, the transportation device is a 4-wheel vehicle. Furthermore, according to one embodiment, the motorized wheels can be controlled individually. It should be noted that various types of steering are possible according to the present invention. One such example is front wheel steering.

According to one preferred embodiment, the standing and/or walking space is arranged between a left bottom support and a right bottom support up to a front framework. Moreover, according to yet another embodiment, the transportation device has an open space, for feet clearance while walking, under the front framework.

The combination of a suitably positioned standing and/or walking space and standing portions is one advantage according to the present invention. In this context it may be mentioned that according to one embodiment, the transportation device comprises a left bottom support having at least two left standing portions and a right bottom support having at least two right standing portions, said standing portions being two separate user ride-on units. Furthermore, according to yet another embodiment, rear standing portions are each positioned on top of the left rear and right rear wheels, respectively, and wherein front standing portions are each positioned between the front wheels and rear wheels on the left and right side of the vehicle, respectively, preferably said front standing portions are arranged as lowered U shaped surfaces (see FIG. 1). Moreover, one or several user standing portion(s) may also function as loading surface(s).

The steering functions may vary according to the present invention. According to one embodiment, the transportation device comprises steering means, with a combination of mechanical steering and electrical steering. In this context it should be understood that also only mechanical steering or electrical steering is possible according to the present invention. Moreover, with electrical steering one specific alternative is so called servo/power steering.

Furthermore, also other means may be arranged to control the transportation device according to the present invention. In line with this, according to one embodiment, the transportation device is controllable using controls being part of the vehicle, such as joystick, throttle, brake, or handlebar, and/or by external devices (remotely and/or wireless), such as a smartphone, gamepad, computer or server, e.g. via the cloud. Such control means may imply means for accelerating, braking and/or steering. Moreover, according to one embodiment, the transportation device is controllable using a smartphone. According to yet another embodiment, the transportation device is controllable via a remote server. Furthermore, the combination of the above is also possible, that is to incorporate mechanical steering and one or several control units for controlling speed and/or braking, such as a control unit placed on a steering wheel or handlebar or the like. Moreover, to use an electronic control unit for speed, braking and steering and mechanical means simultaneously is also possible according to the present invention.

If one or several control units are arranged on the device, this may be placed in different positions. According to one embodiment, the control unit is positioned or placeable in close connection to the left handle and/or the right handle. It should be noted the control unit may be wireless and therefore placeable in different positions. Moreover, with such a control unit the transportation device may be driven remotely. Furthermore, the transportation device may also be driven remotely by use of another device, such as a mobile phone or computer unit. According to yet another embodiment, the transportation device is driven autonomously.

According to yet another embodiment, the transportation device is foldable. According to one specific embodiment, the steering column is foldable down towards the frame, preferably by the steering column being fixated to a front frame portion of the frame via a hinge. Moreover, according to yet another embodiment, an upper steering column and a lower steering column are arranged to be slided into one another.

The transportation device may be folded together in different ways. According to one embodiment, the frame comprises two lower sides which can be folded together. This alternative is not shown in the figures.

Furthermore, according to yet another embodiment, the transportation device is arranged to stand by itself on its rear end(s). This is preferable for enabling better storage of the transportation device. Moreover, according to yet another embodiment of the present invention, the transportation device is arranged so that when the steering column is folded down into the frame, the rear of the folded transportation device has a footprint large enough to support its center of gravity so it can stand by itself upright on its rear end(s). As seen in FIG. 2, it should be noted that when folded together, the steering column with the steering means may be kept inside of the frame so that nothing protrudes out from the rear ends. This is an advantage with this embodiment of the present invention.

According to yet another embodiment, the transportation device also comprises a seat unit, preferably a foldable and/or removable seat unit. It should be noted that the seat unit may be a separate component, totally optional.

Also the geometrical architecture is relevant. According to one embodiment of the present invention, the transportation device has a profile so that the rear standing portions have a higher vertical position than the front standing portions when the transportation device and its wheels are standing on a plane surface in regular operation mode, preferably said front standing portions are arranged as lowered U shaped surfaces, allowing for the front standing portions to be positioned lower than the top surface of the wheel in order to achieve a low height for stepping up to and down from, as well as moving in and out from the vehicle from the sides. For example, according to one embodiment, the distance in height between the rear standing portions and the front standing portions is at least 5 cm.

Also other add-ons and functionalities may be provided on the transportation device according to the invention. According to one embodiment, the frame can have an extra frame component that is fixed to and joins the frame sides in order to further increase the strength of the frame and/or create a large area for; extra loading, further standing portions, extra accessory fixation points. Moreover, the transportation device may also comprise a bottom frame that is adjustable in width, allowing for different sized users and multiple modes of transportation. According to yet another embodiment, the transportation device also comprises a handle at the front of the transportation device, to be used for lifting/carrying or manually rolling the transportation device on the back wheels, when folded, preferably a foldable and/or extendable and/or removable handle.

Furthermore, the steering column and handlebar may be adjustable in height and/or in angle, allowing for different sized users and multiple modes of transportation.

As may be understood from above, the device according to the present invention is preferably directed to a solution where a user has the possibility to walk inside the frame, i.e. walk inside of the wheelbase rather than outside the wheelbase as is standard in known solutions.

As mentioned, the transportation device according to the present invention may also have other capabilities. Examples are:
It may be possible to fold/disassemble/transform in order to reduce its size/footprint. For example for storage, packaging or transit.
As said, it may be possible to adjust/modify/customize in order to fit different user preferences. For example height or physical ability.
It may be possible to adjust/modify/customize in order to fit different use-cases. For example golfing, shopping or goods transport.
As said, the load carrying area(s), suitably placed in the front, may be extended with different added accessories.

As should be understood from above, different user cases are possible according to the present invention.

Moreover, and as mentioned, the transportation device according to the present invention suitably has at least four operation modes for a user, said four operation modes being a) user/users standing ride-on, suitably on any of the rear and front left standing portions and right standing portions; b) walking manually with support for loading capabilities; c) walking with motorized assistance; d) transporting cargo only—without manually pushing the transportation device or ride-on, and preferably also a fifth operation mode being user/users seated ride-on.

### DETAILED DESCRIPTION OF THE DRAWINGS

In FIG. 1 there is provided a transportation device 1 according to one embodiment of the present invention. The transportation device 1 comprises multiple motorized wheels, at least two out of the four wheels 4L, 4R, 5L, 5R present, for propulsion of the transportation device 1. Moreover, the transportation device 1 comprises at least one user ride-on unit 50, in this case two separate user standing portions 6L, 6R. Furthermore, the transportation device 1 comprises a frame 70 arranged to provide a standing and/or walking space for the user.

Moreover, in this embodiment, the transportation device 1 also comprises several loading surfaces 10, such as one positioned on top of a front frame portion 95, and also others provided by said user standing portions 6L, 6R and also from rear standing portions 12L and 12R (also provides as ride-on units 50).

According to this embodiment, the transportation device 1 has a steering column 90, a throttle control 11, battery 13, steering means 14 and a manual brake unit 15. Moreover, the steering column 90 comprises an upper steering column 8U being arranged to be slided into a lower steering column 8L.

As may be understood from FIG. 2, the transportation device 1 according to this embodiment is foldable. In this case, the steering column 90 is foldable down towards the frame 70 by the steering column 90 being fixated to a front frame portion 95 of the frame 70 via a hinge 18.

When the steering column 90 is folded down, the transportation device 1 is arranged to stand by itself on its rear end(s) 30.

Furthermore, in this case the transportation device 1 has a profile so that the rear standing portions 12L, 12R have a higher vertical position than the front standing portions 6L, 6R when the transportation device 1 and its wheels 4L, 4R, 5L, 5R are standing on a plane surface in regular operation mode, so that the front standing portions 6L, 6R are arranged as lowered U shaped surfaces.

In FIG. 2, the same embodiment as in FIG. 1 is shown, however in this case folded together. As may be seen, handle 19 provides a simple means for carrying or rolling the transportation device 1 when being folded together.

1. A transportation device (1) comprising multiple motorized wheels, for propulsion of the transportation device (1), wherein the transportation device (1) comprises at least one user ride-on unit (50), wherein the transportation device (1) has at least 4 wheels (4L, 4R, 5L, 5R), and wherein the transportation device (1) comprises a frame (70) arranged to provide a standing and/or walking space for the user.

2. The transportation device (1) according to claim 1, wherein said at least one ride-on unit (50) is two separate user standing portions.

3. The transportation device (1) according to claim 1, wherein the transportation device (1) also comprises a loading surface (10), preferably several loading surfaces (10), and wherein at least one loading surface (10) is positioned on top of a front frame portion (95).

4. A transportation device (1) comprising multiple motorized wheels, for propulsion of the transportation device (1), wherein the transportation device (1) comprises at least one user ride-on unit (50), wherein the transportation device (1) has at least 4 wheels, and wherein said at least one ride-on unit (50) is two separate user standing portions (6L, 12L, 6R, 12R).

5. The transportation device (1) according to claim 4, wherein the transportation device (1) comprises a frame (70) arranged to provide a standing and/or walking space for the user.

6. The transportation device (1) according to claim 4, wherein the transportation device (1) also comprises a loading surface (10), preferably several loading surfaces (10), and wherein at least one loading surface (10) is positioned on top of the front frame portion (95).

7. A transportation device (1) comprising multiple motorized wheels, for propulsion of the transportation device (1), wherein the transportation device (1) comprises at least one user ride-on unit (50), wherein the transportation device (1) has at least 4 wheels, and wherein the transportation device (1) also comprises a loading surface (10), preferably several loading surfaces (10), and wherein at least one loading surface (10) is positioned on top of a front frame portion (95).

8. The transportation device (1) according to claim 7, wherein the transportation device (1) comprises a frame (70) arranged to provide a standing and/or walking space for the user.

9. The transportation device (1) according to claim 7, wherein said at least one ride-on unit (50) is two separate user standing portions.

10. The transportation device (1) according to claim 1, wherein the transportation device (1) comprises two loading surfaces (10) positioned at a part of the frame (70) positioned above each front wheel (5L, 5R), said two loading surfaces (10) located on either side of a steering column (90).

11. The transportation device (1) according to claim 1, wherein the transportation device (1) comprises at least one loading surface (10) which is a front loading surface (95) positioned at part of the frame (70) positioned above each front wheel (5L, 5R), said one front loading surface (95) extends on both sides of a steering column (90), preferably said one front loading surface (95) has a minimum surface area of 100 cm².

12. The transportation device (1) according to claim 1, wherein the transportation device is a 4-wheel vehicle.

13. The transportation device (1) according to claim 1, wherein the motorized wheels can be controlled individually.

14. The transportation device (1) according to claim 1, wherein the standing and/or walking space is arranged between a left bottom support (3L) and a right bottom support (3R) up to a front framework (7).

15. The transportation device (1) according to claim 14, wherein the transportation device (1) has an open space, for feet clearance while walking, under the front framework (7).

16. The transportation device (1) according to claim 1, wherein the transportation device (1) comprises a left bottom support (3L) having at least two left standing portions (6L, 12L) and a right bottom support (3R) having at least two right standing portions (6R, 12R), said standing portions (6L, 12L, 6R, 12R) being two user ride-on units (50).

17. The transportation device (1) according to claim 16, wherein rear standing portions (12L, 12R) are each positioned on top of the left rear and right rear wheels (4L, 4R), respectively, and wherein front standing portions (6L, 6R) are each positioned between the front wheels (5L, 5R) and rear wheels (4L, 4R) on the left and right side of the vehicle, respectively, preferably said front standing portions (6L, 6R) are arranged as lowered U shaped surfaces.

18. The transportation device (1) according to claim 4, wherein each user standing portion (6L, 12L, 6R, 12R) is arranged to also function as a loading surface (10).

19. The transportation device (1) according to claim 1, wherein the transportation device (1) comprises steering means (14), with a combination of mechanical steering and electrical steering.

20. The transportation device (1) according to claim 1, wherein the transportation device (1) is controllable using controls being part of the vehicle, such as joystick, throttle, brake, or handlebar, and/or by external devices, such as a smartphone, gamepad, computer or server.

21. The transportation device (1) according to claim 1, wherein the transportation device (1) is foldable.

22. The transportation device (1) according to claim 1, wherein a steering column (90) is foldable down towards the frame (70), preferably by the steering column (90) being fixated to a front frame portion (95) of the frame (70) via a hinge (18).

23. The transportation device (1) according to claim 1, wherein a steering column (90) comprises an upper steering column (8U) and a lower steering column (8L) arranged to be slided into one another.

24. The transportation device (1) according to claim 1, wherein the transportation device (1) is arranged to stand by itself on any of its end(s).

25. (canceled)

26. The transportation device (1) according to claim 1, wherein the transportation device (1) also comprises a seat unit, preferably a foldable and/or removable seat unit.

27. The transportation device (1) according to claim 4, wherein the transportation device (1) has a profile so that the rear standing portions (12L, 12R) have a higher vertical position than the front standing portions (6L, 6R) when the transportation device (1) and its wheels (4L, 4R, 5L, 5R) are standing on a plane surface in regular operation mode, preferably said front standing portions (6L, 6R) are arranged as lowered U shaped surfaces.
